(19) United States
(12) Patent Application Publication
(10) Pub. No.: US 2026/0134498 A1
(43) Pub. Date: May 14, 2026

(54) METHOD AND APPARATUSES FOR SCHEDULING SERVICES RUNNING ON GRAPHICS PROCESSING UNITS

(71) Applicant: Alipay (Hangzhou) Information Technology Co., Ltd., Hangzhou (CN)

(72) Inventor: Jia Liu, Hangzhou (CN)

(73) Assignee: Alipay (Hangzhou) Information Technology Co., Ltd., Hangzhou (CN)

(21) Appl. No.: 19/015,180

(22) Filed: Jan. 9, 2025

(30) Foreign Application Priority Data
Jan. 9, 2024 (CN) 202410040401.3

(51) Int. Cl. G06T 1/20; G06T 1/60

(52) U.S. Cl. CPC G06T 1/20; G06T 1/60

(57) ABSTRACT

Scheduling services running on graphics processing units (GPUs) is described. For each of a plurality of GPUs, a consumed video memory capacity used to run services on the GPU, a total video memory capacity corresponding to the GPU, and types and a quantity of service instances running on each GPU of the plurality of GPUs is obtained, where service instances of one or more services run on each GPU, and where the service instance of each service runs on one or more GPUs. A predicted video memory capacity consumed by service instances of various services is determined. The determination is based on the consumed video memory capacity, the total video memory capacity, and the types and the quantity of the service instances running on each GPU of the plurality of GPUs, where the predicted video memory capacity is used to allocate video memory to the service instances.

### TECHNICAL FIELD

One or more embodiments of this specification relate to the field of graphics processing units and service scheduling, and in particular, to methods and apparatuses for scheduling services running on graphics processing units.

### BACKGROUND

Currently, many computing services, such as machine learning services, rely on graphics processing units (GPUs) for computing. However, video memory resources of the graphics processing units are usually limited, for example, small machine learning services often need only a small amount of video memory. In order to use graphics processing unit resources more efficiently, an existing conventional method for scheduling services is to deploy a plurality of services on a machine equipped with graphics processing units. However, this existing method for scheduling services has the problem of wasting video memory resources, or the problem of service deployment failures due to insufficient video memory resources.

### SUMMARY

This specification describes one or more embodiments of a method and apparatus for scheduling services running on graphics processing units (GPUs). The method can determine the predicted video memory consumption of various services based on the total video memory consumption of services already running on multiple GPUs and the type of service, and deploy the services accordingly. This can significantly improve the utilization of video memory resources in the deployment and operation of GPU-based services, as well as reduce the occurrence of service deployment failures due to insufficient video memory, thus addressing the shortcomings of existing technologies.

According to a first aspect, a method for scheduling services running on graphics processing units is provided. The method includes: obtaining, for each of a plurality of graphics processing units, a consumed video memory capacity that has been used to run services on the graphics processing unit, and a total video memory capacity corresponding to the graphics processing unit; obtaining types and a quantity of service instances running on each of the plurality of graphics processing units, where service instances of one or more services run on each graphics processing unit, and the service instance of each service runs on one or more graphics processing units; and determining a predicted video memory capacity respectively consumed by service instances of various services, based on the consumed video memory capacity of each of the plurality of graphics processing units, the total video memory capacity of each of the plurality of graphics processing units, and the types and the quantity of the service instances running on each of the plurality of graphics processing units, where the predicted video memory capacity is used to allocate video memory to the service instances running on the graphics processing units.

In a possible implementation, the determining a predicted video memory capacity consumed by instances of various services in the predetermined type of services, based on the consumed video memory capacity of each of the plurality of graphics processing units, the total video memory capacity of each of the plurality of graphics processing units, and the service instances running on each of the plurality of graphics processing units includes: substituting the consumed video memory capacity of the plurality of graphics processing units, the total video memory capacity of each of the plurality of graphics processing units, and the types and the quantity of the service instances running on each of the plurality of graphics processing units into a plurality of predetermined inequalities corresponding to the plurality of graphics processing units, where the predetermined inequalities are used to indicate that the sum of the predicted video memory capacity consumed by the service instances running on the graphics processing units is greater than or equal to the consumed video memory capacity of the graphics processing units and less than or equal to the total video memory capacity of the graphics processing units; and solving the plurality of predetermined inequalities to obtain the predicted video memory capacity consumed by the service instances of various services.

In a possible implementation, the solving the plurality of predetermined inequalities to obtain a predicted video memory capacity consumed by a single instance of various services includes: solving the plurality of predetermined inequalities to obtain an initial predicted capacity consumed by the service instances of various services, and updating the initial predicted capacity with the objective of minimizing a difference between the sum of the predicted video memory capacity consumed by the service instances running on the graphics processing units and the consumed video memory capacity of the graphics processing units, to obtain the predicted video memory capacity.

In a possible implementation, each of the service instances runs on a virtual container.

In a possible implementation, the method further includes: writing the predicted video memory capacity to a service resource ledger included in a service scheduler for use by the service scheduler to allocate, based on the service resource ledger, video memory to the service instances running on the graphics processing units. In a possible implementation, the subgraph matching task includes a plurality of supersteps based on a bulk synchronous parallel (BSP) computing model, where the first substep corresponds to the first superstep of the plurality of supersteps.

In a possible implementation, the service instances of one or more services run on each graphics processing unit, including: service instances of one or more services in a target service type set run on each graphics processing unit; and the determining a predicted video memory capacity respectively consumed by service instances of various services includes: determining a predicted video memory capacity respectively consumed by service instances of various services in the target service type set.

In a possible implementation, the obtaining, for each of a plurality of graphics processing units, a consumed video memory capacity that has been used to run services on the graphics processing unit, and a total video memory capacity corresponding to the graphics processing unit includes: obtaining, for each of a plurality of graphics processing units, a consumed video memory capacity that has been used to run services on the graphics processing unit, and a total video memory capacity corresponding to the graphics processing unit, in response to a change in the target service type set.

In a possible implementation, the change in the target service type set includes: adding or removing a service type to or from the target service type set.

According to a second aspect, an apparatus for scheduling services running on graphics processing units is provided. The apparatus includes: a first acquisition unit configured to obtain, for each of a plurality of graphics processing units, a consumed video memory capacity that has been used to run services on the graphics processing unit, and a total video memory capacity corresponding to the graphics processing unit; a second acquisition unit configured to obtain types and a quantity of service instances running on each of the plurality of graphics processing units, where service instances of one or more services run on each graphics processing unit, and the service instance of each service runs on one or more graphics processing units; and a prediction unit configured to determine a predicted video memory capacity respectively consumed by service instances of various services, based on the consumed video memory capacity of each of the plurality of graphics processing units, the total video memory capacity of each of the plurality of graphics processing units, and the types and the quantity of the service instances running on each of the plurality of graphics processing units, where the predicted video memory capacity is used to allocate video memory to the service instances running on the graphics processing units.

According to a third aspect, a computer-readable storage medium storing a computer program is provided. The computer program, when executed in a computer, causes the computer to perform the method according to the first aspect.

According to a fourth aspect, a computing device including a memory and a processor is provided. The memory stores executable code, and when the processor executes the executable code, the method according to the first aspect is implemented. With one or more of the method, the apparatus, the computing device, and the storage medium in the above-mentioned aspects, the utilization of video memory resources can be significantly improved in the deployment and operation of GPU-based services. In addition, the occurrence of service deployment failures due to insufficient video memory is reduced.

### BRIEF DESCRIPTION OF DRAWINGS

To describe the technical solutions in the embodiments of this application more clearly, the following briefly describes the accompanying drawings needed for describing the embodiments. Clearly, the accompanying drawings in the following description show merely some embodiments of this application, and a person of ordinary skill in the art can still derive other drawings from these accompanying drawings without creative efforts.

FIG. 1 is a schematic diagram illustrating a solution for deploying services by evenly allocating video memory;

FIG. 2 is a schematic diagram illustrating a solution for deploying services by manually predicting video memory usage;

FIG. 3 is a schematic diagram illustrating a method for scheduling services running on graphics processing units, according to some embodiments of this specification;

FIG. 4 is a flowchart illustrating a method for scheduling services running on graphics processing units, according to some embodiments of this specification;

FIG. 5 is a schematic diagram illustrating a method for scheduling services running on graphics processing units, according to another embodiment of this specification;

FIG. 6 is a schematic diagram illustrating a process of determining the predicted video memory consumption of various services, according to some embodiments of this specification; and

FIG. 7 is a structural diagram illustrating an apparatus for scheduling services running on graphics processing units, according to some embodiments of this specification.

### DESCRIPTION OF EMBODIMENTS

The solutions provided in this specification are described below with reference to the accompanying drawings.

As described above, currently, many computing services, such as machine learning services, rely on graphics processing units (GPUS) for computing. To be specific, these computing services are usually deployed on machines equipped with GPUs. However, video memory resources of graphics processing units are usually limited, for example, video memory resources of some graphics processing units are 16G to 24G. For example, the operation of some machine learning services often needs only a small amount of video memory. For example, taking a small machine learning model, namely bidirectional encoder representations from transformers (BERT), as an example, the operation of the model often needs only 1G to 2G of video memory. In order to use graphics processing units more efficiently, an existing conventional method for scheduling services is to deploy a plurality of services on a machine equipped with graphics processing units. In an production environment, in order to maintain independence among services, so that the operation of different services does not interfere with each other, virtualization technologies (such as virtual containers) can usually be used to achieve resource isolation among the services. For example, each machine learning service provides an external service interface through a virtual container, and a plurality of containers share a GPU video card (or briefly referred to as a GPU card) on a physical machine. The GPU video card usually includes a display chip (to be specific, a graphics processing unit (GPU)), a video RAM (briefly referred to as video memory), and other components. For ease of description, video memory of a GPU video card can be briefly referred to as video memory of a GPU. However, generally, after virtualization, due to restriction of hardware and permissions, it is difficult to obtain video memory actually occupied by each container service, and overall video memory usage of the entire physical machine can be periodically obtained, for example, only by executing scripts.

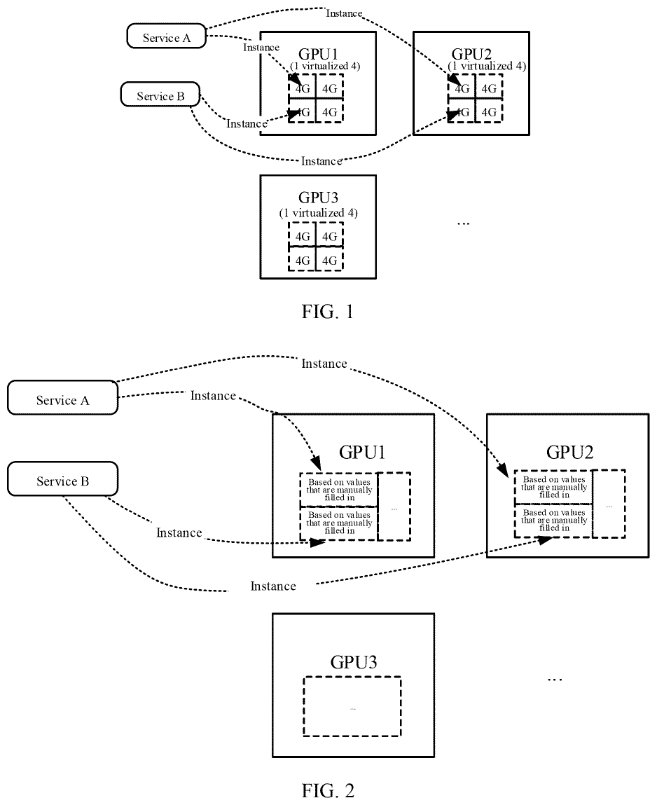

In general, for example, when an online machine learning service is deployed, video memory resources needed for the service can be requested. Because the amount of video memory actually occupied by services during running cannot be obtained, one of the current solutions to determine the amount of video memory requested for various services is to virtualize one GPU card into a plurality of virtual cards by using a GPU virtualization technology. For example, in one example, a GPU card can be virtualized into 4 virtual cards (or briefly referred to as 1 virtualized 4). In another example, a GPU card can be virtualized into 8 virtual cards (or briefly referred to as 1 virtualized 8). After a GPU card is virtualized, each virtual card obtains the same size of video memory. For example, after a 24G GPU card goes through 1 virtualized 8, a video memory capacity of each virtual card is 3G. When video memory is allocated to various services, each service can be allocated with a virtual card to run the service, and the video memory that can be used by the service is video memory of the virtual card. FIG. 1 is a schematic diagram illustrating a solution for deploying services by evenly allocating video memory. In the example shown in FIG. 1, when service instances of various services (including, for example, service A and service B) are deployed, an allocated video memory capacity is a video memory capacity of a virtual card, for example, 4G. For example, the essence of this solution is to evenly allocate video memory for various services. However, the disadvantage of this solution is that video memory actually used by different services cannot be distinguished, which often leads to waste of video memory resources and deployment failure of services. For example, if a virtual card has 4G of video memory, but its allocated service actually only uses 2G, then the remaining 2G of video memory is wasted. The waste of video memory resources can lead to deployment failures of services that should have been deployed due to lack of video memory.

Another solution to determine the amount of video memory requested for various services is to manually predict the consumption of video cards for different services. According to this solution, when various services are deployed, a scheduler (or referred to as a service scheduler) used to deploy services can request video memory resources for various services based on video memory usage recorded in a built-in resource ledger, and the video memory usage of various services in the resource ledger can be filled in by manual prediction. FIG. 2 is a schematic diagram illustrating a solution for deploying services by manually predicting video memory usage. As shown in FIG. 2, service instances of various services (including, for example, service A and service B), when deployed, can be allocated with used video memory based on different predicted values manually filled in the ledger. However, the disadvantage of this solution is that there is often a gap between predicted values that are manually filled in and the actual amount of video memory for services during running. In actual production occasions, there is often a large gap between predicted values that are manually filled in and the amount of video memory actually used by services at runtime, including situations where the predicted values are higher than the amount of video memory actually used, or lower than the amount of video memory actually used. In one example, one service can request 1G of video memory but actually uses 10G of video memory. In another example, another service can also request 10G but actually uses 1G. The problem of mismatch between predicted usage recorded in this ledger and actual usage can also lead to waste of video memory resources and failure of service deployment.

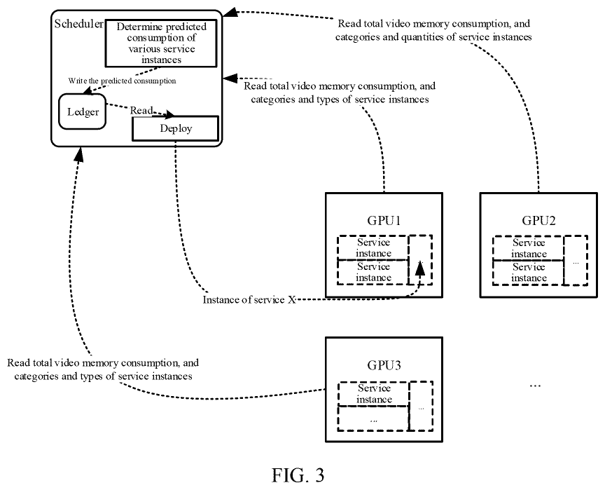

To resolve the above-mentioned technical problem, some embodiments of this specification provide a method for scheduling services running on graphics processing units. A core idea of the method is to obtain, for each of a plurality of graphics processing units, a consumed video memory capacity that has been used to run services on the graphics processing unit, and a total video memory capacity of the graphics processing unit, and types and a quantity of service instances running on each of the plurality of graphics processing units. Based on the obtained data, a predicted video memory capacity respectively consumed by service instances of various services is determined and written to a resource ledger of a service scheduler for use by the service scheduler, for example, to allocate video memory to services deployed afterwards. FIG. 3 is a schematic diagram illustrating a method for scheduling services running on graphics processing units, according to some embodiments of this specification. In the example shown in FIG. 3, the service scheduler obtains, for example, a consumed video memory capacity that has been used to run services on a plurality of GPUs (for example, GPU1, GPU2, GPU3, . . . ), a consumed video memory capacity of each of the GPUs, and types (i.e., service types) and a quantity of service instances running on each of the GPUs. Based on these obtained data, a predicted video memory capacity consumed during running of service instances of various services can be determined and written to a resource ledger of a service scheduler for use by the service scheduler to allocate, based on the resource ledger, video memory used by service instances (for example, service instances of service X that is included in a service type whose predicted video memory capacity is determined) running thereafter.

With this method, predicted values of video memory actually consumed by various services during running can be automatically estimated when the amount of video memory actually consumed by various services during running cannot be directly obtained, and occupied video memory for various services can be allocated based on the predicted values. This greatly mitigates the problem of wasting video memory resources in service scheduling based on GPU computing, and reduce the occurrence of service deployment failures due to insufficient video memory resources.

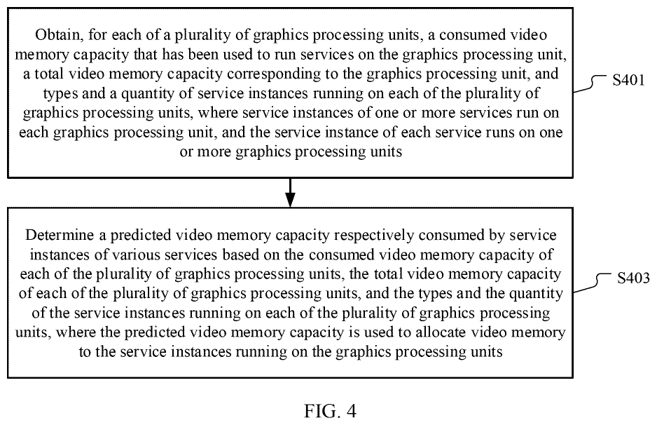

The following describes in detail a method for scheduling services running on graphics processing units, according to some embodiments of this specification. FIG. 4 is a flowchart illustrating a method for scheduling services running on graphics processing units, according to some embodiments of this specification. As shown in FIG. 4, the method includes at least the following steps.

Step S401: Obtain, for each of a plurality of graphics processing units, a consumed video memory capacity that has been used to run services on the graphics processing unit, a total video memory capacity corresponding to the graphics processing unit, and types and a quantity of service instances running on each of the plurality of graphics processing units, where service instances of one or more services run on each graphics processing unit, and the service instance of each service runs on one or more graphics processing units.

Step S403: Determine a predicted video memory capacity respectively consumed by service instances of various services based on the consumed video memory capacity of each of the plurality of graphics processing units, the total video memory capacity of each of the plurality of graphics processing units, and the types and the quantity of the service instances running on each of the plurality of graphics processing units, where the predicted video memory capacity is used to allocate video memory to the service instances running on the graphics processing units.

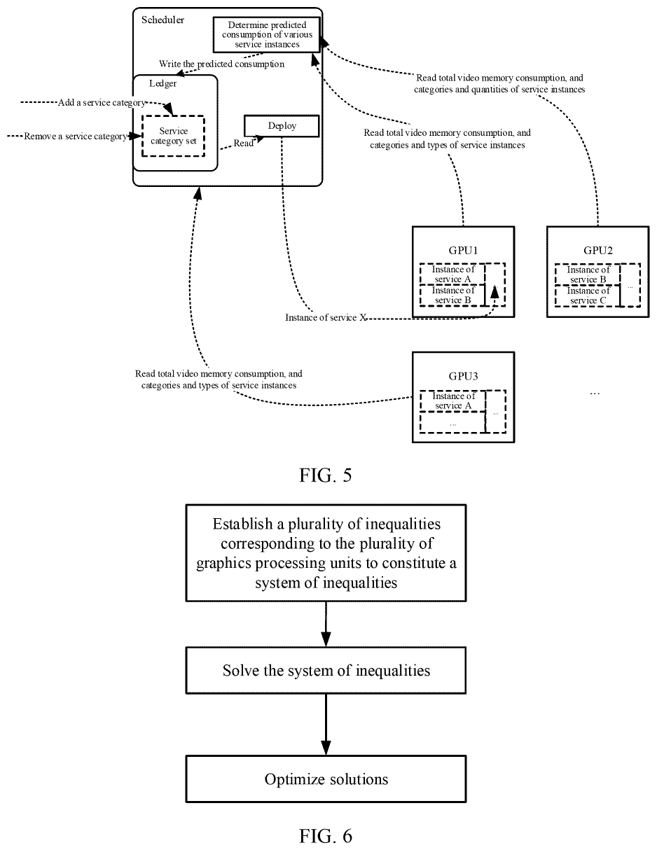

First, in step S401, for each of the plurality of graphics processing units, the consumed video memory capacity that has been used to run services on the graphics processing unit, and the total video memory capacity corresponding to the graphics processing unit, and the types and the quantity of the service instances running on each of the plurality of graphics processing units are obtained. Generally, service instances of one or more services can run on each graphics processing unit, and the service instance of each service can run on one or more graphics processing units. A service can be a program used to provide a particular function. A service instance is a specific instance of a service. In an actual production environment, such as a cloud computing environment or a virtualized environment, each service can usually have a plurality of instances and can be deployed on different GPU machines. In different embodiments, each service instance at runtime can receive and respond to service requests independently, or communicate and cooperate with other service instances. For example, in the example shown in FIG. 5, different instances of service A can be deployed, for example, on GPU1 and GPU3, and different instances of service B can be deployed on GPU1 and GPU2. In different embodiments, specific types and functions of services running on each graphics processing unit can be different. Implementations are not limited in this specification. In one embodiment, a service running on a graphics processing unit can be used, for example, to run a machine learning model. In different specific embodiments, different services running on graphics processing units can be used to run different specific types of machine learning models. In one example, for example, one or more of a bidirectional encoder representations from transformers (BERT) model, a Transformer model, a graph neural network (GNN), or a convolutional neural network (CNN) can be run.

As described above, in some production scenarios, resource isolation between services can be achieved through virtual containers to avoid the running of different services interfering with each other. For example, each service runs in a virtual container and provides an external interface through the virtual container. Therefore, in one embodiment, each service instance can run on a virtual container. In different specific embodiments, service instances can run on different specific types of virtual containers. Implementations are not limited in this specification.

Generally, types of services running on the plurality of graphics processing units can be determined. In one embodiment, these determined service types can, for example, constitute a target service type set. Therefore, in a specific embodiment, service instances of one or more services in the target service type set can run on each graphics processing unit.

In actual production occasions, service types in the target service type set can change, for example, a new service (running through these graphics processing units) is deployed online or a deployed service (running through these graphics processing units) is offline. Therefore, when a service type in the target service type set changes, prediction can be initiated for video memory consumed by each service type in the changed target service type set. It can be understood that service types in the target service type set can change multiple times, and prediction can also be initiated multiple times for video memory consumed by each service type. Therefore, in one embodiment, for each of a plurality of graphics processing units, a consumed video memory capacity that has been used to run services on the graphics processing unit, and a total video memory capacity corresponding to the graphics processing unit can be obtained in response to a change in the target service type set. In a specific embodiment, the change in the target service type set can include: adding or removing a service type to or from the target service type set.

After the consumed video memory capacity and the total video memory capacity of each of the plurality of graphics processing units, and the types and the quantity of the service instances running on each of the plurality of graphics processing units are determined, in step S403, a predicted video memory capacity respectively consumed by the service instances of various services can be determined based on the consumed video memory capacity of each of the plurality of graphics processing units, the total video memory capacity of each of the plurality of graphics processing units, and the types and the quantity of the service instances running on each of the plurality of graphics processing units, where the predicted video memory capacity is used to allocate video memory to the service instances running on the graphics processing units.

In this step, the predicted video memory capacity respectively consumed by the service instances of various services can be calculated based on the consumed video memory capacity of each of the plurality of graphics processing units, the total video memory capacity of each of the plurality of graphics processing units, and the types and the quantity of the service instances running on each of the plurality of graphics processing units, that are obtained in step S401. In the above embodiments in which the types of services running on the graphics processing units constitute the target service type set, a predicted video memory capacity respectively consumed by the service instances of various services in the target service type set can be determined.

In different embodiments, specific ways to determine the predicted video memory capacity consumed by the service instances of various services can be different. FIG. 6 is a schematic diagram illustrating a process of determining predicted video memory consumption of various services, according to some embodiments of this specification. In the embodiments as shown in FIG. 6, the consumed video memory capacity of the plurality of graphics processing units, the total video memory capacity of each of the plurality of graphics processing units, and the types and the quantity of the service instances running on each of the plurality of graphics processing units can be substituted into a plurality of predetermined inequalities corresponding to the plurality of graphics processing units, where the predetermined inequalities are used to indicate that the sum of the predicted video memory capacity consumed by the service instances running on the graphics processing units is greater than or equal to the consumed video memory capacity of the graphics processing units and less than or equal to the total video memory capacity of the graphics processing units; and the plurality of predetermined inequalities are solved to obtain the predicted video memory capacity consumed by the service instances of various services. To obtain a predicted video memory capacity that is closer to actual video memory consumed by each service, an initial predicted capacity consumed by each service can also be obtained by solving the predetermined inequalities, and the initial predicted capacity is optimized based on a predetermined optimization condition, so as to obtain the predicted video memory capacity. Therefore, in a specific embodiment, the plurality of predetermined inequalities can be solved to obtain an initial predicted capacity consumed by the service instances of various services, and the initial predicted capacity is updated with the objective of minimizing a difference between the sum of the predicted video memory capacity consumed by the service instances running on the graphics processing units and the consumed video memory capacity of the graphics processing units, to obtain the predicted video memory capacity. For example, in a specific example, for example, three GPU cards, namely, GPU1, GPU2 and GPU3, are used to run service A, service B and service C. GPU1, GPU2 and GPU3 each have 24G of video memory, and service A and service B run on GPU1, consuming 5G of video memory in total; service B and service C run on GPU2, consuming 7G of video memory in total; and service A and service C run on GPU3, consuming 6G of video memory in total. Then, the following system of inequalities corresponding to the three GPU cards can be obtained:

$$\{ \begin{matrix}24 \geq a + b \geq 5 \\ 24 \geq b + c \geq 7 \\ 24 \geq a + c \geq 6\end{matrix} \qquad ( 1 )$$

where a, b and c are predicted video memory capacities respectively consumed by service A, service B and service C (a>=0, b>=0, c>=0); and =the system of inequalities (1) is solved to obtain solutions to a, b and c, namely aϵ[12,2], bϵ[12,3] and cϵ[12,4], that is, initial intervals (i.e., initial predicted capacities) of predicted video memory capacities of video memory consumed by service A, service B and service C, that is, the predicted video memory capacity of video memory consumed by service A is within the interval [12,2], the predicted video memory capacity consumed by service B is within the interval [12,3], and the predicted video memory capacity consumed by service C is within the interval [12,4].

Then, based on the following formula:

$$minimize \{ ( a + b - 5 ) + ( b + c - 7 ) + ( a + c - 6 ) \} \qquad ( 2 )$$

values of a, b and c can be optimized to obtain final values of the predicted video memory capacity, i.e., a=2, b=3, and c=4.

The predicted video memory capacity, after being determined, can be used to allocate video memory to the service instances running on the graphics processing units. As described above, in some scenarios, a scheduler (or referred to as a service scheduler) used to deploy services can request video memory resources for various services based on video memory usage of various services that is recorded in a built-in resource ledger. Therefore, the predicted video memory capacity that is determined can be used as video memory usage of various services and written into the built-in ledger of the scheduler for use by the scheduler to request video memory resources when various services are deployed afterwards, as shown in FIG. 6. Therefore, in one embodiment, the predicted video memory capacity can be written to a service resource ledger included in a service scheduler for use by the service scheduler to allocate, based on the service resource ledger, video memory to the service instances running on the graphics processing units.

In conclusion, the method has the following advantages: on the one hand, accurate predicted values of the amount of video memory actually consumed by various services during running can be automatically calculated when the amount of video memory actually consumed by various services during running cannot be directly obtained, and occupied video memory for various services can be allocated based on the predicted values. As such, the waste of allocated video memory resources due to inaccurate estimation of video memory consumption in service scheduling based on GPU computing is greatly reduced, and the utilization of video memory resources is improved. On the other hand, the probability of service deployment failures due to insufficient video memory resources is significantly reduced, and a success rate of service deployment under the same resource condition is improved.

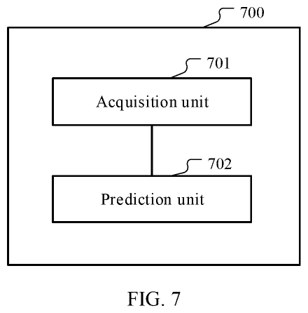

On the other hand, corresponding to the above-mentioned method process, some embodiments of this specification further disclose an apparatus for scheduling services running on graphics processing units. FIG. 7 is a structural diagram illustrating an apparatus for scheduling services running on graphics processing units, according to some embodiments of this specification. As shown in FIG. 7, the apparatus 700 includes: an acquisition unit 701 configured to obtain, for each of a plurality of graphics processing units, a consumed video memory capacity that has been used to run services on the graphics processing unit, a total video memory capacity corresponding to the graphics processing unit, and types and a quantity of service instances running on each of the plurality of graphics processing units, where service instances of one or more services run on each graphics processing unit, and the service instance of each service runs on one or more graphics processing units; and a prediction unit 702 configured to determine a predicted video memory capacity respectively consumed by service instances of various services, based on the consumed video memory capacity of each of the plurality of graphics processing units, the total video memory capacity of each of the plurality of graphics processing units, and the types and the quantity of the service instances running on each of the plurality of graphics processing units, where the predicted video memory capacity is used to allocate video memory to the service instances running on the graphics processing units.

Another aspect of some embodiments of this specification provides a computer-readable storage medium storing a computer program that, when executed in a computer, causes the computer to perform any one of the above-mentioned methods.

Still another aspect of some embodiments of this specification provides a computing device, including a memory and a processor, where the memory stores executable code, and when the processor executes the executable code, any one of the above-mentioned methods is implemented.

It should be understood that descriptions such as “first” and “second” in this specification are merely intended to distinguish a similar concept for simplicity of descriptions, and do not have another limitation function.

Although one or more embodiments of this specification provide the method operation steps described in the embodiments or flowcharts, more or fewer operation steps can be included based on conventional or non-creative means. A sequence of steps listed in an embodiment is merely one of various step execution sequences and does not indicate a sole execution sequence. In practice, when being executed by an apparatus or an end-user device product, the steps can be executed sequentially or in parallel (for example, by parallel processors or in a multi-thread processing environment, or even in a distributed data processing environment) based on the method shown in the embodiments or the accompanying drawings. The terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, the existence of additional identical or equivalent elements in the process, method, product or device that includes the elements is not excluded.

For ease of description, the above-mentioned apparatuses are described separately by dividing functions into various modules. Certainly, during implementation of one or more embodiments of this specification, the functions of the modules can be implemented in same one or more pieces of software and/or hardware, or modules implementing a same function can be implemented by using a combination of a plurality of sub-modules or sub-units, etc. The described apparatus embodiments are merely examples. For example, division into the units is merely logical function division and there can be other division manners in actual implementation. For example, a plurality of units or components can be combined or integrated into another system, or some features may be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

A person skilled in the art should be aware that one or more embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The one or more embodiments of this specification can be described in the general context of computer-executable instructions, for example, a program module. Generally, the program module includes a routine, a program, an object, a component, a data structure, and the like executing a specific task or implementing a specific abstract data type. The one or more embodiments of this specification can alternatively be practiced in distributed computing environments. In the distributed computing environments, tasks are executed by remote processing devices that are connected through a communication network. In the distributed computing environments, the program module can be located in both local and remote computer storage media including storage devices.

The embodiments of this specification are described in a progressive manner. For same or similar parts in the embodiments, mutual references can be made to the embodiments. Each embodiment focuses on a difference from other embodiments. Particularly, some system embodiments are briefly described because they are basically similar to some method embodiments. For related parts, references can be made to related descriptions in some method embodiments. In the descriptions of this specification, descriptions of reference to terms such as “an embodiment”, “some embodiments”, “an example”, “a specific example”, or “some examples” mean that specific features, structures, materials, or characteristics described with reference to the embodiment or example are included in at least one embodiment or example of this specification. In this specification, illustrative expressions of the above-mentioned terms are not necessarily intended for the same embodiment or example. In addition, the described specific feature, structure, material, or characteristic can be combined in a proper manner in any one or more embodiments or examples. Moreover, a person skilled in the art can combine and associate different embodiments or examples and features of different embodiments or examples described in this specification, provided that the embodiments or examples and the features do not conflict with each other.

The above-mentioned descriptions are merely embodiments of the one or more embodiments of this specification, and are not intended to limit the one or more embodiments of this specification. A person skilled in the art knows that one or more embodiments of this specification can have various modifications and changes. Any modifications, equivalent replacements, improvements, etc. made without departing from the spirit and principle of this specification shall fall within the scope of the claims.

1-11. (canceled)

12. A computer-implemented method for scheduling services running on graphics processing units (GPUs), comprising:
obtaining, for each GPU of a plurality of GPUs, a consumed video memory capacity that has been used to run services on the GPU, a total video memory capacity corresponding to the GPU, and types and a quantity of service instances running on each GPU of the plurality of GPUs, wherein service instances of one or more services run on each GPU, and the service instance of each service runs on one or more GPUs; and
determining a predicted video memory capacity respectively consumed by service instances of various services, based on the consumed video memory capacity of each GPU of the plurality of GPUs, the total video memory capacity of each GPU of the plurality of GPUs, and the types and the quantity of the service instances running on each GPU of the plurality of GPUS, wherein the predicted video memory capacity is used to allocate video memory to the service instances running on the GPUs.

13. The computer-implemented method of claim 12, wherein determining a predicted video memory capacity respectively consumed by instances of various services, based on the consumed video memory capacity of each GPU of the plurality of GPUs, the total video memory capacity of each GPU of the plurality of GPUs, and the types and the quantity of the service instances running on each GPU of the plurality of GPUs, comprises:
substituting the consumed video memory capacity of the plurality of GPUs, the total video memory capacity of each GPU of the plurality of GPUs, and the types and the quantity of the service instances running on each GPU of the plurality of GPUs into a plurality of predetermined inequalities corresponding to the plurality of GPUs, wherein the predetermined inequalities are used to indicate that a sum of the predicted video memory capacity consumed by the service instances running on the GPUs is greater than or equal to the consumed video memory capacity of the GPUs and less than or equal to the total video memory capacity of the GPUs; and
solving the plurality of predetermined inequalities to obtain the predicted video memory capacity consumed by the service instances of various services.

14. The computer-implemented method of claim 13, wherein solving the plurality of predetermined inequalities to obtain a predicted video memory capacity consumed by a single instance of various services, comprises:
solving the plurality of predetermined inequalities to obtain an initial predicted capacity consumed by the service instances of various services, and updating the initial predicted capacity with an objective of minimizing a difference between the sum of the predicted video memory capacity consumed by the service instances running on the GPUs and the consumed video memory capacity of the GPUs, to obtain the predicted video memory capacity.

15. The computer-implemented method of claim 12, wherein each service instance of the quantity of service instances runs on a virtual container.

16. The computer-implemented method of claim 12, comprising:
writing the predicted video memory capacity to a service resource ledger included in a service scheduler for use by the service scheduler to allocate, based on the service resource ledger, video memory to the service instances running on the GPUs.

17. The computer-implemented method of claim 12, wherein:
the service instances of one or more services run on each GPU;
service instances of one or more services in a target service type set run on each GPU; and
determining a predicted video memory capacity respectively consumed by service instances of various services, comprises:
determining a predicted video memory capacity respectively consumed by service instances of various services in the target service type set.

18. The computer-implemented method of claim 17, wherein obtaining, for each of a plurality of GPUs, a consumed video memory capacity that has been used to run services on the GPU, and a total video memory capacity corresponding to the GPU, comprises:
obtaining, for each of a plurality of GPUs, a consumed video memory capacity that has been used to run services on the GPU, and a total video memory capacity corresponding to the GPU, in response to a change in the target service type set.

19. The computer-implemented method of claim 18, wherein the change in the target service type set comprises: adding or removing a service type to or from the target service type set.

20. A non-transitory, computer-readable medium storing one or more instructions executable by a computer system to perform one or more operations for scheduling services running on graphics processing units (GPUs), comprising:
obtaining, for each GPU of a plurality of GPUs, a consumed video memory capacity that has been used to run services on the GPU, a total video memory capacity corresponding to the GPU, and types and a quantity of service instances running on each GPU of the plurality of GPUS, wherein service instances of one or more services run on each GPU, and the service instance of each service runs on one or more GPUs; and
determining a predicted video memory capacity respectively consumed by service instances of various services, based on the consumed video memory capacity of each GPU of the plurality of GPUs, the total video memory capacity of each GPU of the plurality of GPUs, and the types and the quantity of the service instances running on each GPU of the plurality of GPUS, wherein the predicted video memory capacity is used to allocate video memory to the service instances running on the GPUs.

21. The non-transitory, computer-readable medium of claim 20, wherein determining a predicted video memory capacity respectively consumed by instances of various services, based on the consumed video memory capacity of each GPU of the plurality of GPUs, the total video memory capacity of each GPU of the plurality of GPUs, and the types and the quantity of the service instances running on each GPU of the plurality of GPUs, comprises:
substituting the consumed video memory capacity of the plurality of GPUs, the total video memory capacity of each GPU of the plurality of GPUs, and the types and the quantity of the service instances running on each GPU of the plurality of GPUs into a plurality of predetermined inequalities corresponding to the plurality of GPUs, wherein the predetermined inequalities are used to indicate that a sum of the predicted video memory capacity consumed by the service instances running on the GPUs is greater than or equal to the consumed video memory capacity of the GPUs and less than or equal to the total video memory capacity of the GPUs; and
solving the plurality of predetermined inequalities to obtain the predicted video memory capacity consumed by the service instances of various services.

22. The non-transitory, computer-readable medium of claim 21, wherein solving the plurality of predetermined inequalities to obtain a predicted video memory capacity consumed by a single instance of various services, comprises:
solving the plurality of predetermined inequalities to obtain an initial predicted capacity consumed by the service instances of various services, and updating the initial predicted capacity with an objective of minimizing a difference between the sum of the predicted video memory capacity consumed by the service instances running on the GPUs and the consumed video memory capacity of the GPUs, to obtain the predicted video memory capacity.

23. The non-transitory, computer-readable medium of claim 20, wherein each service instance of the quantity of service instances runs on a virtual container.

24. The non-transitory, computer-readable medium of claim 20, comprising:
writing the predicted video memory capacity to a service resource ledger included in a service scheduler for use by the service scheduler to allocate, based on the service resource ledger, video memory to the service instances running on the GPUs.

25. The non-transitory, computer-readable medium of claim 20, wherein:
the service instances of one or more services run on each GPU;
service instances of one or more services in a target service type set run on each GPU; and
determining a predicted video memory capacity respectively consumed by service instances of various services, comprises:
determining a predicted video memory capacity respectively consumed by service instances of various services in the target service type set.

26. The non-transitory, computer-readable medium of claim 25, wherein obtaining, for each of a plurality of GPUs, a consumed video memory capacity that has been used to run services on the GPU, and a total video memory capacity corresponding to the GPU, comprises:
obtaining, for each of a plurality of GPUs, a consumed video memory capacity that has been used to run services on the GPU, and a total video memory capacity corresponding to the GPU, in response to a change in the target service type set.

27. The non-transitory, computer-readable medium of claim 26, wherein the change in the target service type set comprises: adding or removing a service type to or from the target service type set.

28. A computer-implemented system for scheduling services running on graphics processing units (GPUs), comprising:
one or more computers; and
one or more computer memory devices interoperably coupled with the one or more computers and having tangible, non-transitory, machine-readable media storing one or more instructions that, when executed by the one or more computers, perform one or more operations, comprising:
obtaining, for each GPU of a plurality of GPUs, a consumed video memory capacity that has been used to run services on the GPU, a total video memory capacity corresponding to the GPU, and types and a quantity of service instances running on each GPU of the plurality of GPUs, wherein service instances of one or more services run on each GPU, and the service instance of each service runs on one or more GPUs; and
determining a predicted video memory capacity respectively consumed by service instances of various services, based on the consumed video memory capacity of each GPU of the plurality of GPUs, the total video memory capacity of each GPU of the plurality of GPUs, and the types and the quantity of the service instances running on each GPU of the plurality of GPUS, wherein the predicted video memory capacity is used to allocate video memory to the service instances running on the GPUs.

29. The computer-implemented system of claim 28, wherein determining a predicted video memory capacity respectively consumed by instances of various services, based on the consumed video memory capacity of each GPU of the plurality of GPUs, the total video memory capacity of each GPU of the plurality of GPUs, and the types and the quantity of the service instances running on each GPU of the plurality of GPUs, comprises:
substituting the consumed video memory capacity of the plurality of GPUs, the total video memory capacity of each GPU of the plurality of GPUs, and the types and the quantity of the service instances running on each GPU of the plurality of GPUs into a plurality of predetermined inequalities corresponding to the plurality of GPUs, wherein the predetermined inequalities are used to indicate that a sum of the predicted video memory capacity consumed by the service instances running on the GPUs is greater than or equal to the consumed video memory capacity of the GPUs and less than or equal to the total video memory capacity of the GPUs; and
solving the plurality of predetermined inequalities to obtain the predicted video memory capacity consumed by the service instances of various services.

30. The computer-implemented system of claim 29, wherein solving the plurality of predetermined inequalities to obtain a predicted video memory capacity consumed by a single instance of various services, comprises:
solving the plurality of predetermined inequalities to obtain an initial predicted capacity consumed by the service instances of various services, and updating the initial predicted capacity with an objective of minimizing a difference between the sum of the predicted video memory capacity consumed by the service instances running on the GPUs and the consumed video memory capacity of the GPUs, to obtain the predicted video memory capacity.

31. The computer-implemented system of claim 28, wherein each service instance of the quantity of service instances runs on a virtual container.
